(19) United States
(12) Patent Application Publication
(10) Pub. No.: US 2016/0323919 A1
(43) Pub. Date: Nov. 3, 2016

(54) METHOD AND APPARATUS FOR OBTAINING INFORMATION FOR 3GPP LTE-WLAN INTERWORKING IN WIRELESS COMMUNICATION SYSTEM

(71) Applicant: LG ELECTRONICS INC., Seoul (KR)

(72) Inventors: Jian XU, Seoul (KR); Jaewook LEE, Seoul (KR); Kyungmin PARK, Seoul (KR); Daewook BYUN, Seoul (KR)

(73) Assignee: LG ELECTRONICS INC., Seoul (KR)

(21) Appl. No.: 15/108,240

(22) PCT Filed: Jan. 9, 2015
(86) PCT No.: PCT/KR2015/000257

§ 371 Date: Jun. 24, 2016

Related U.S. Application Data
(60) Provisional application No. 61/925,662, filed on Jan. 10, 2014.
(60) Provisional application No. 61/927,988, filed on Jan. 16, 2014.

(51) Int. Cl. H04W 76/02; H04W 28/12; H04L 5/00; H04W 28/02; H04J 11/00; H04H 20/38

(52) U.S. Cl. CPC H04W 76/021; H04J 11/00; H04H 20/38; H04L 5/0055; H04W 28/0226; H04W 28/12; H04W 84/12

(57) ABSTRACT

A method and apparatus for obtaining wireless local area network (WLAN) information in a wireless communication system is provided. An evolved NodeB (eNB) transmits an indication of WLAN offloading support to a mobility management entity (MME), and receiving a list of supported WLAN from the MME. The eNB may decide which access point name (APN), among a list of common APNs, to offload, and broadcast WLAN information and the decided APN to user equipments (UEs). Alternatively, the eNB may decide which APN to offload for a specific UE, and transmit WLAN information and the decided APN to the specific UE via a dedicated signaling.

### BACKGROUND OF THE INVENTION

1. Field of the Invention

The present invention relates to wireless communications, and more particularly, to a method and apparatus for obtaining information for 3rd generation partnership project (3GPP) long-term evolution (LTE)-wireless local area network (WLAN) interworking in a wireless communication system.

2. Related Art

Universal mobile telecommunications system (UMTS) is a 3rd generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), an access point, etc. One eNB 20 may be deployed per cell.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) and a system architecture evolution (SAE) gateway (S-GW). The MME/S-GW 30 may be positioned at the end of the network and connected to an external network. For clarity, MME/S-GW 30 will be referred to herein simply as a “gateway,” but it is understood that this entity includes both the MME and S-GW.

The MME provides various functions including non-access stratum (NAS) signaling to eNBs 20, NAS signaling security, access stratum (AS) security control, inter core network (CN) node signaling for mobility between 3GPP access networks, idle mode UE reachability (including control and execution of paging retransmission), tracking area list management (for UE in idle and active mode), packet data network (PDN) gateway (P-GW) and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on access point name aggregate maximum bit rate (APN-AMBR).

Interfaces for transmitting user traffic or control traffic may be used. The UE 10 is connected to the eNB 20 via a Uu interface. The eNBs 20 are connected to each other via an X2 interface. Neighboring eNBs may have a meshed network structure that has the X2 interface. A plurality of nodes may be connected between the eNB 20 and the gateway 30 via an S1 interface.

FIG. 2 shows a block diagram of architecture of a typical E-UTRAN and a typical EPC. Referring to FIG. 2, the eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE_ACTIVE state. In the EPC, and as noted above, gateway 30 may perform functions of paging origination, LTE_IDLE state management, ciphering of the user plane, SAE bearer control, and ciphering and integrity protection of NAS signaling.

FIG. 3 shows a block diagram of a user plane protocol stack and a control plane protocol stack of an LTE system. FIG. 3-(a) shows a block diagram of a user plane protocol stack of an LTE system, and FIG. 3-(b) shows a block diagram of a control plane protocol stack of an LTE system. Layers of a radio interface protocol between the UE and the E-UTRAN may be classified into a first layer (L1), a second layer (L2), and a third layer (L3) based on the lower three layers of the open system interconnection (OSI) model that is well-known in the communication system.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data between the MAC layer and the PHY layer is transferred through the transport channel. Between different PHY layers, i.e., between a PHY layer of a transmission side and a PHY layer of a reception side, data is transferred via the physical channel.

A MAC layer, a radio link control (RLC) layer, and a packet data convergence protocol (PDCP) layer belong to the L2. The MAC layer provides services to the RLC layer, which is a higher layer of the MAC layer, via a logical channel. The MAC layer provides data transfer services on logical channels. The RLC layer supports the transmission of data with reliability. Meanwhile, a function of the RLC layer may be implemented with a functional block inside the MAC layer. In this case, the RLC layer may not exist. The PDCP layer provides a function of header compression function that reduces unnecessary control information such that data being transmitted by employing IP packets, such as IPv4 or IPv6, can be efficiently transmitted over a radio interface that has a relatively small bandwidth.

A radio resource control (RRC) layer belongs to the L3. The RLC layer is located at the lowest portion of the L3, and is only defined in the control plane. The RRC layer controls logical channels, transport channels, and physical channels in relation to the configuration, reconfiguration, and release of radio bearers (RBs). The RB signifies a service provided the L2 for data transmission between the UE and E-UTRAN.

Referring to FIG. 3-(a), the RLC and MAC layers (terminated in the eNB on the network side) may perform functions such as scheduling, automatic repeat request (ARQ), and hybrid ARQ (HARQ). The PDCP layer (terminated in the eNB on the network side) may perform the user plane functions such as header compression, integrity protection, and ciphering.

Referring to FIG. 3-(b), the RLC and MAC layers (terminated in the eNB on the network side) may perform the same functions for the control plane. The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

FIG. 4 shows an example of a physical channel structure. A physical channel transfers signaling and data between PHY layer of the UE and eNB with a radio resource. A physical channel consists of a plurality of subframes in time domain and a plurality of subcarriers in frequency domain. One subframe, which is 1 ms, consists of a plurality of symbols in the time domain. Specific symbol(s) of the subframe, such as the first symbol of the subframe, may be used for a physical downlink control channel (PDCCH). The PDCCH carries dynamic allocated resources, such as a physical resource block (PRB) and modulation and coding scheme (MCS).

A DL transport channel includes a broadcast channel (BCH) used for transmitting system information, a paging channel (PCH) used for paging a UE, a downlink shared channel (DL-SCH) used for transmitting user traffic or control signals, a multicast channel (MCH) used for multicast or broadcast service transmission. The DL-SCH supports HARQ, dynamic link adaptation by varying the modulation, coding and transmit power, and both dynamic and semi-static resource allocation. The DL-SCH also may enable broadcast in the entire cell and the use of beamforming.

A UL transport channel includes a random access channel (RACH) normally used for initial access to a cell, a uplink shared channel (UL-SCH) for transmitting user traffic or control signals, etc. The UL-SCH supports HARQ and dynamic link adaptation by varying the transmit power and potentially modulation and coding. The UL-SCH also may enable the use of beamforming.

The logical channels are classified into control channels for transferring control plane information and traffic channels for transferring user plane information, according to a type of transmitted information. That is, a set of logical channel types is defined for different data transfer services offered by the MAC layer.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting multimedia broadcast multicast services (MBMS) control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RRC state indicates whether an RRC layer of the UE is logically connected to an RRC layer of the E-UTRAN. The RRC state may be divided into two different states such as an RRC idle state (RRC_IDLE) and an RRC connected state (RRC_CONNECTED). In RRC_IDLE, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE, no RRC context is stored in the eNB.

In RRC_CONNECTED, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion. A paging message is transmitted over all cells belonging to the same tracking area. If the UE moves from one tracking area (TA) to another TA, the UE will send a tracking area update (TAU) message to the network to update its location.

3GPP LTE-wireless local area network (WLAN) interworking and integration is currently supported by 3GPP specifications at the CN level, including both seamless and non-seamless mobility to WLAN. An efficient method for offloading from 3GPP LTE to WLAN may be required.

### SUMMARY OF THE INVENTION

The present invention provides a method and apparatus for obtaining information for 3rd generation partnership project (3GPP) long-term evolution (LTE)-wireless local area network (WLAN) interworking in a wireless communication system. The present invention provides a method for transmitting an indication of WLAN offloading support, and receiving a list of supported WLAN.

In an aspect, a method for obtaining, by an evolved NodeB (eNB), wireless local area network (WLAN) information in a wireless communication system is provided. The method includes transmitting an indication of WLAN offloading support to a mobility management entity (MME), and receiving a list of supported WLAN from the MME.

In another aspect, a method for transmitting, by a mobility management entity (MME), wireless local area network (WLAN) information in a wireless communication system is provided. The method includes receiving an indication of WLAN offloading support from an evolved NodeB (eNB), and transmitting a list of supported WLAN to the eNB.

Offloading from 3GPP LTE to WLAN can be performed efficiently.

### BRIEF DESCRIPTION OF THE DRAWINGS

FIG. 1 shows LTE system architecture.

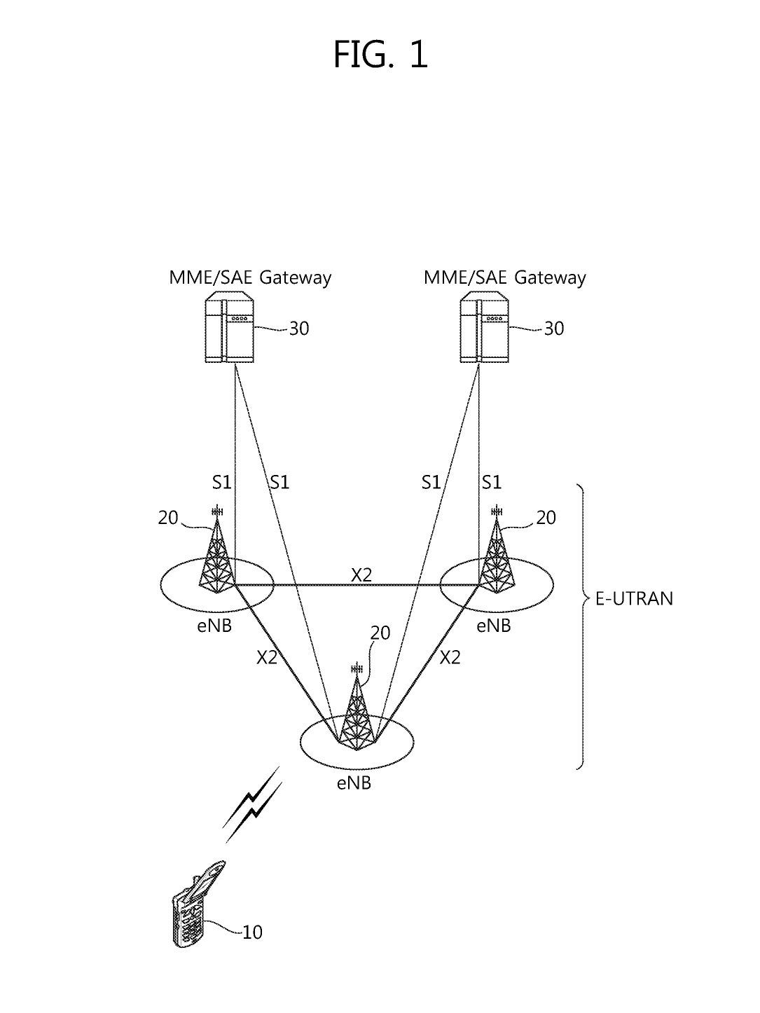

FIG. 2 shows a block diagram of architecture of a typical E-UTRAN and a typical EPC.

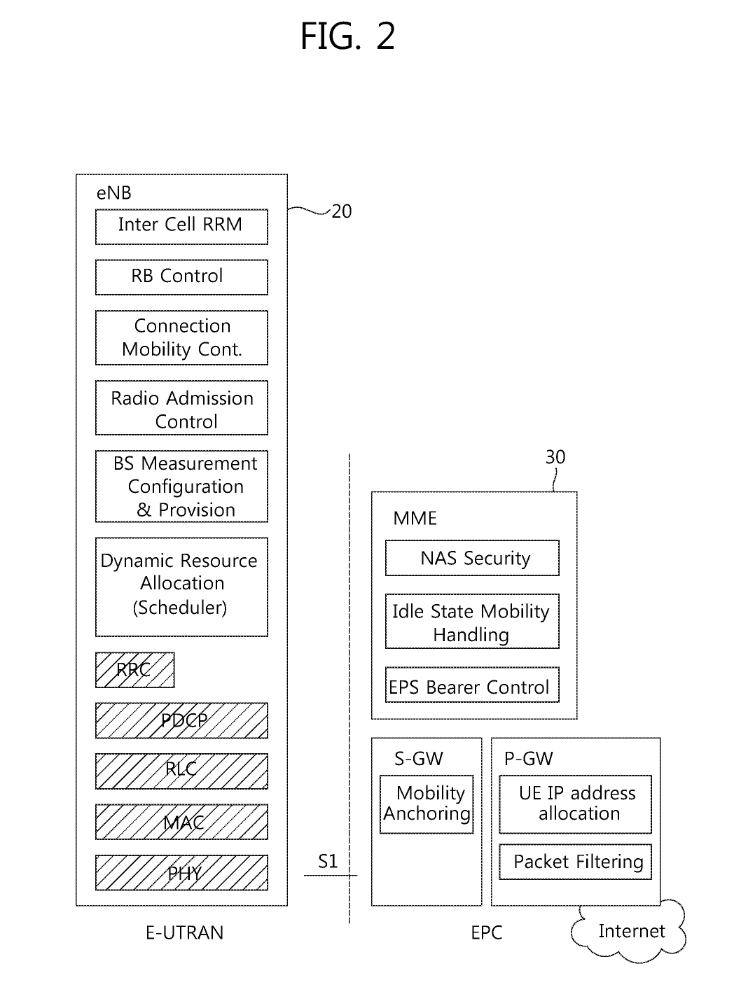

FIG. 3 shows a block diagram of a user plane protocol stack and a control plane protocol stack of an LTE system.

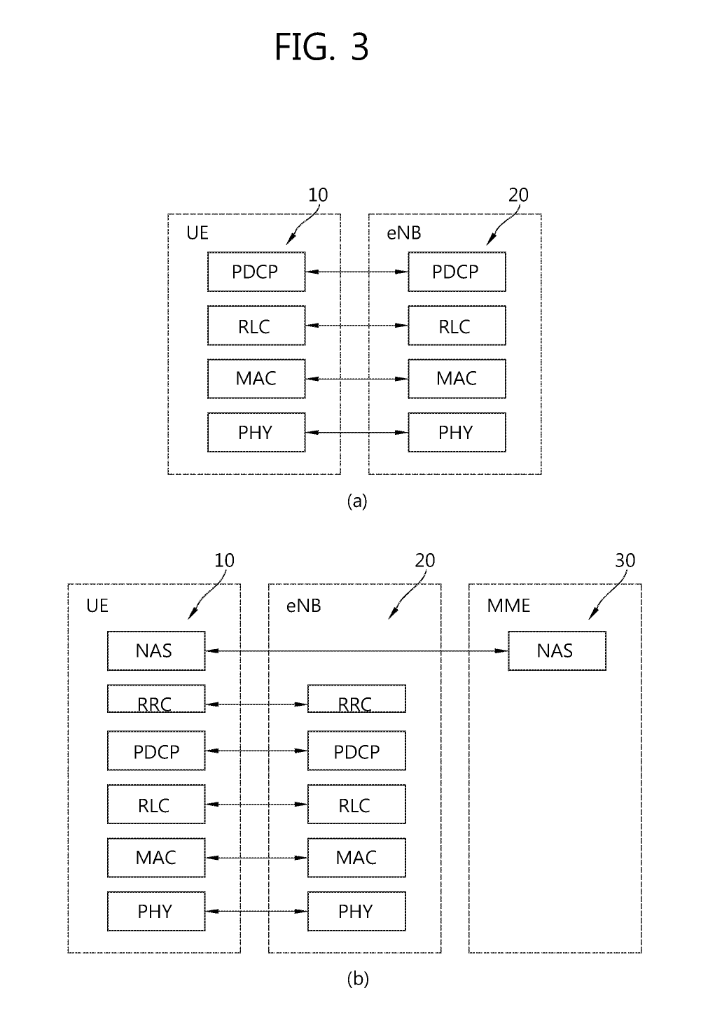

FIG. 4 shows an example of a physical channel structure.

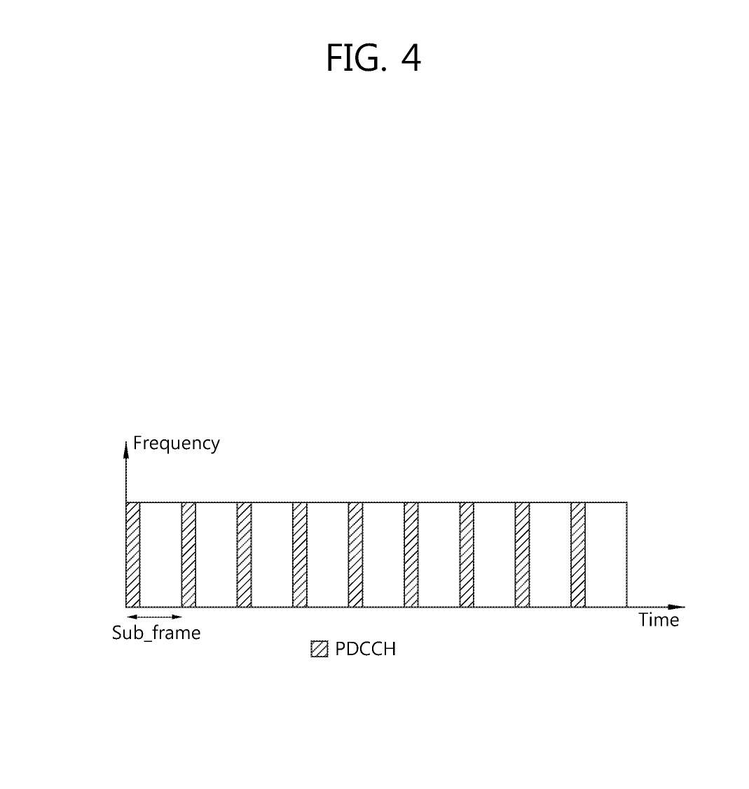

FIG. 5 shows an example of 3GPP LTE-WLAN interworking architecture.

FIG. 6 shows another example of 3GPP LTE-WLAN interworking architecture.

FIG. 7 shows another example of 3GPP LTE-WLAN interworking architecture.

FIG. 8 shows an example of a method for obtaining WLAN information according to an embodiment of the present invention.

FIG. 9 shows a wireless communication system to implement an embodiment of the present invention.

### DESCRIPTION OF EXEMPLARY EMBODIMENTS

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink. LTE-advance (LTE-A) is an evolution of the 3GPP LTE.

For clarity, the following description will focus on the LTE-A. However, technical features of the present invention are not limited thereto.

3GPP LTE-wireless local area network (WLAN) interworking is described.

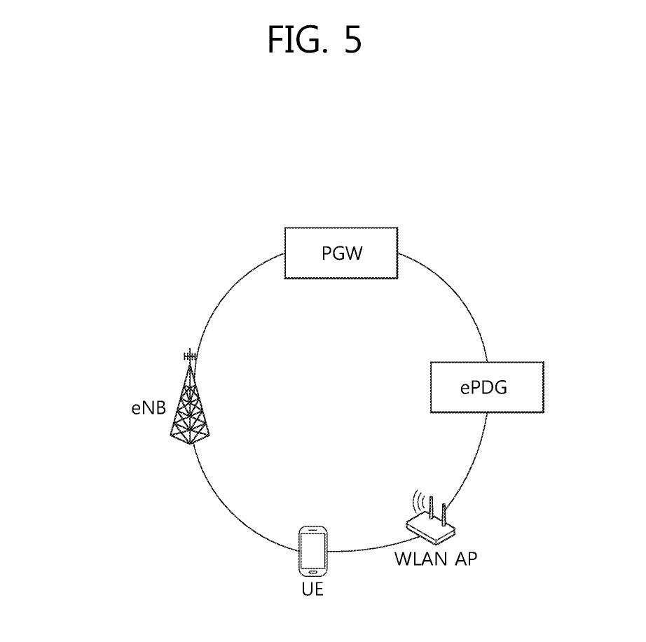

FIG. 5 shows an example of 3GPP LTE-WLAN interworking architecture. Referring to FIG. 5, a user equipment (UE) has a connection with a packet data network (PDN) gateway (P-GW) via an eNodeB (eNB) in 3GPP LTE, and has a connection with the P-GW via an access point (AP) in WLAN. The AP and the P-GW may be connected via an evolved packet data gateway (ePDG).

The scenario considered in 3GPP LTE-WLAN may focus on WLAN nodes deployed and controlled by operators and their partners. There may be several WLAN APs within the coverage of a single UTRAN/E-UTRAN cell. The eNB/radio network controller (RNC) may know the location or other WLAN AP parameters (e.g. basic service set identifier (BSSID), channel, etc. . . . ), however scenarios where such information is not available should be supported as well. There is no radio access network (RAN)-level information exchange between HeNBs/eNBs/RNCs and APs via standardized interface. Some information exchange may be possible via operations, administration and management (OAM).

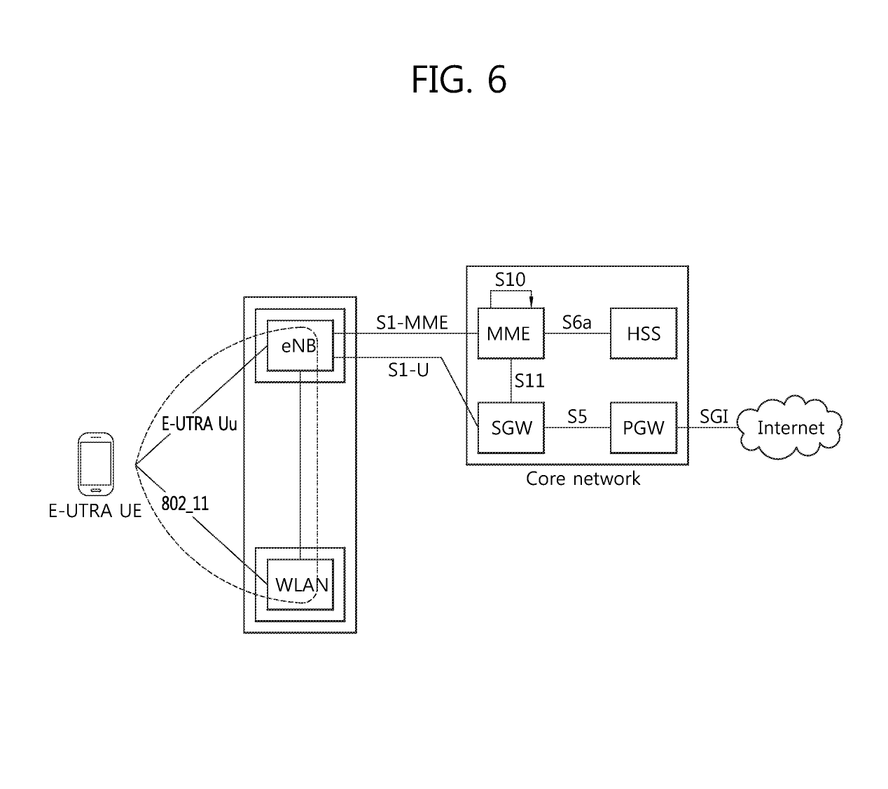

FIG. 6 shows another example of 3GPP LTE-WLAN interworking architecture. Referring to FIG. 6, the eNB and WLAN can be co-located and can be also connected through interface. The data packets are split on eNB side.

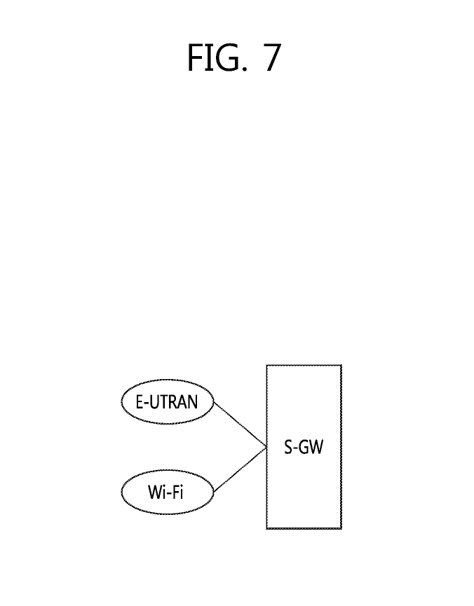

FIG. 7 shows another example of 3GPP LTE-WLAN interworking architecture. Referring to FIG. 7, the eNB and WLAN can be co-located and can be also connected through interface. The data packets are split on S-GW side.

The following use cases may be considered for 3GPP LTE-WLAN interworking:
UE is within UTRAN/E-UTRAN coverage, is using 3GPP and goes into WLAN AP coverage
UE is within UTRAN/E-UTRAN and WLAN coverage, is using WLAN and goes out of WLAN AP coverage
UE is within the coverage area of both, UE using WLAN, all or a subset of the UE's traffic should be routed via UTRAN/E-UTRAN instead
UE is within the coverage area of both, UE using UTRAN/E-UTRAN, all or a subset of the UE's traffic should be routed via WLAN instead
UE using both accesses and should be connected to only one (WLAN or UTRAN/E-UTRAN) or some traffic should be moved to the other access

In order to perform offloading from LTE to WLAN efficiently, it is necessary for the RAN node to be aware of the WLAN information for both UE specific and non-UE specific scenarios. For example, since the UE may be allowed to use WLAN or not, the RAN node needs to obtain the WLAN information. In addition, depending on the load situation or other reasons, the RAN node should decide how to offload and to which WLAN to offload by transmitting broadcasting or dedicated signaling to the UE.

The current mechanism does not support transmitting UE's subscription information to the RAN node. Also, for broadcasting scenario, non-UE specific scheme should be found. Further, for handover situation, the problem has also to be solved, in case that the target eNB would do offloading in the future. To solve the problems described above, followings according to an embodiment of the present invention are described for different situations.

1) First, a method for broadcasting according to an embodiment of the present invention is described. This scheme applies to all the idle mode UEs connected mode UEs for which broadcasting is used instead of dedicated signaling. In the method for broadcasting according to an embodiment of the present invention, the eNB transmits a clear indication of WLAN offloading support to a mobility management entity (MME). Upon receiving the indication of the WLAN offloading support, the MME transmits a list of common supported WLAN to the eNB. The list of common supported WLAN may indicate the common possible WLAN related IDs for the eNB, which may apply to all UEs or partial of UEs. Further, the MME may transmit a list of common access point names (APNs) that may be offloaded when offloading is necessary, together with the list of common supported WLAN. The list of common APNs may indicate the common possible APNs which can be offloaded, which may apply to all UEs or partial UEs, for example, internet service, etc. Upon receiving the list of common supported WLAN, and optionally, the list of common APNs, the eNB decides which APN to offload based on its current load, and broadcast WLAN information (e.g., SSID) and APN to all UEs, which may apply both the idle mode UEs and connected mode UEs.

The indication of the WLAN offloading support, the list of common supported WLAN, and the list of common APNs described above may be transmitted via existing messages specified in 3GPP LTE specification or via newly defined messages, in the method for broadcasting according to an embodiment of the present invention. Various messages carrying the indication of the WLAN offloading support, the list of common supported WLAN, and the list of common APNs, in the method for broadcasting according to an embodiment of the present invention are described below.

The indication of the WLAN offloading support may be transmitted via an S1 setup request message, which is specified in section 9.1.8.4 of 3GPP TS 36.413 V11.6.0 (2013-12). The S1 setup request message is transmitted by the eNB to transfer information for a transport network layer (TNL) association. Table 1 and 2 shows an example of the S1 setup request message according to an embodiment of the present invention.

TABLE 1

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.1.1 | | YES | reject |
| Global Enb ID | M | | 9.2.1.37 | | YES | reject |
| Enb Name | O | | Printable | | YES | ignore |
| | | | String(1 . . . 150, . . . ) | | | |
| Supported Tas | | 1 . . . <maxnoofTACs> | | Supported | GLOBAL | reject |
| | | | | Tas in | | |
| | | | | the Enb. | | |
| >TAC | M | | 9.2.3.7 | Broadcasted | — | |
| | | | | TAC. | | |
| >Broadcast | | 1 . . . <maxnoofBPLMNs> | | Broadcasted | — | |
| PLMNs | | | | PLMNs. | | |
| >>PLMN | M | | 9.2.3.8 | | | |
| Identity | | | | | | |
| Default Paging | M | | 9.2.1.16 | | YES | ignore |
| DRX | | | | | | |
| CSG Id List | | 0 . . . 1 | | | GLOBAL | reject |
| >CSG Id | M | 1 . . . <maxnoofCSGIds> | 9.2.1.62 | | | |
| Indication of | O | | | | | |
| WLAN offloading | | | | | | |
| support | | | | | | |

TABLE 2

| Range bound | Explanation |
|---|---|
| maxnoofTACs | Maximum no. of TACs. Value is 256. |
| MaxnoofBPLMNs | Maximum no. of Broadcasted PLMNs. Value is 6. |
| MaxnoofCSGIds | Maximum no. of CSG Ids within the CSG Id List. |
| | Value is 256. |

Referring to Table 1, the “Indication of WLAN offloading support” field is added to the current S1 setup request message.

When the indication of the WLAN offloading support is transmitted via the S1 setup request message described in Table 1 and 2, the list of common supported WLAN and the list of common APNs may be transmitted via an S1 setup response message, which is specified in section 9.1.8.5 of 3GPP TS 36.413 V11.6.0 (2013-12). The S1 setup response message is transmitted by the MME to transfer information for a TNL association. Table 3 and 4 shows an example of the S1 setup response message according to an embodiment of the present invention.

TABLE 3

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.1.1 | | YES | reject |
| MME Name | O | | PrintableString | | YES | ignore |
| | | | (1 . . . 150, . . . ) | | | |
| Served | | 1 . . . <maxnoofRATs> | | The LTE | GLOBAL | reject |
| GUMMEIs | | | | related pool | | |
| | | | | configuration | | |
| | | | | is included | | |
| | | | | on the first | | |
| | | | | place in the | | |
| | | | | list. | | |
| >Served | | 1 . . . <maxnoofPLMNsPerMME> | | | — | |
| PLMNs | | | | | | |
| >>PLMN | M | | 9.2.3.8 | | — | |
| Identity | | | | | | |
| >Served | | 1 . . . <maxnoofGroupIDs> | | | — | |
| GroupIDs | | | | | | |
| >>MME | M | | OCTET | | — | |
| Group ID | | | STRING | | | |
| | | | (2) | | | |
| >Served | | 1 . . . <maxnoofMMECs> | | | — | |
| MMECs | | | | | | |
| >>MME Code | M | | 9.2.3.12 | | — | |
| Relative MME | M | | 9.2.3.17 | | YES | ignore |
| Capacity | | | | | | |
| MME Relay | O | | 9.2.1.82 | | YES | ignore |
| Support Indicator | | | | | | |
| Criticality | O | | 9.2.1.21 | | YES | ignore |
| Diagnostics | | | | | | |
| List of WLAN | O | | | | | |
| List of Common | O | | | | | |
| offloadable | | | | | | |
| APNs | | | | | | |

TABLE 4

| Range bound | Explanation |
|---|---|
| maxnoofPLMNsPerMME | Maximum no. of PLMNs per MME. Value |
| | is 32. |
| maxnoofRATs | Maximum no. of RATs. Value is 8. |
| maxnoofGroupIDs | Maximum no. of GroupIDs per node per |
| | RAT. Value is 65535. |
| maxnoofMMECs | Maximum no. of MMECs per node per |
| | RAT. Value is 256. |

Referring to Table 3, the “List of WLAN” field and “List of common offloadable APNs” field are added to the current S1 setup response message.

Alternatively, the indication of the WLAN offloading support may be transmitted via an eNB configuration update message, which is specified in section 9.1.8.7 of 3GPP TS 36.413 V11.6.0 (2013-12). The eNB configuration update message is transmitted by the eNB to transfer updated information for a TNL association. Table 5 and 6 shows an example of the eNB configuration update message according to an embodiment of the present invention.

TABLE 5

| | | | IE type | | | |
|---|---|---|---|---|---|---|
| IE/Group | | | and | Semantics | | Assigned |
| Name | Presence | Range | reference | description | Criticality | Criticality |
| Message Type | M | | 9.2.1.1 | | YES | reject |
| eNB Name | O | | Printable | | YES | ignore |
| | | | String(1 . . . 150, . . . ) | | | |
| Supported TAs | | 0 . . . <maxnoofTACs> | | Supported | GLOBAL | reject |
| | | | | TAs in the | | |
| | | | | eNB. | | |
| >TAC | M | | 9.2.3.7 | Broadcasted | — | |
| | | | | TAC. | | |
| >Broadcast | | 1 . . . <maxnoofBPLMNs> | | Broadcasted | — | |
| PLMNs | | | | PLMNs. | | |
| >>PLMN | M | | 9.2.3.8 | | — | |
| Identity | | | | | | |
| CSG Id List | | 0 . . . 1 | | | GLOBAL | reject |
| >CSG Id | | 1 . . . <maxnoofCSGId> | 9.2.1.62 | | — | |
| Default Paging | O | | 9.2.1.16 | | YES | ignore |
| DRX | | | | | | |
| Indication of | O | | | | | |
| WLAN | | | | | | |
| offloading | | | | | | |
| support | | | | | | |

TABLE 6

| Range bound | Explanation |
|---|---|
| maxnoofTACs | Maximum no. of TACs. Value is 256. |
| maxnoofBPLMNs | Maximum no. of Broadcasted PLMNs. Value is 6. |
| maxnoofCSGIds | Maximum no. of CSG Ids within the CSG Id List. |
| | Value is 256. |

Referring to Table 5, the “Indication of WLAN offloading support” field is added to the current eNB configuration update message.

When the indication of the WLAN offloading support is transmitted via the eNB configuration update message described in Table 5 and 6, the list of common supported WLAN and the list of common APNs may be transmitted via an eNB configuration update acknowledge message, which is specified in section 9.1.8.8 of 3GPP TS 36.413 V11.6.0 (2013-12). The eNB configuration update acknowledge message is transmitted by the MME to acknowledge the eNB transfer updated information for a TNL association. Table 7 shows an example of the eNB configuration update acknowledge message according to an embodiment of the present invention.

TABLE 7

| | | | | | | |
|---|---|---|---|---|---|---|
| | | | | Seman- | | |
| | | | IE type | tics | | |
| IE/Group | Pres- | | and | descrip- | Criti- | Assigned |
| Name | ence | Range | reference | tion | cality | Criticality |

| | | | | |
|---|---|---|---|---|
| Message | M | 9.2.1.1 | YES | reject |
| Type | | | | |
| Criticality | O | 9.2.1.21 | YES | ignore |
| Diagnostics | | | | |
| List of WLAN | O | | | |
| List of | O | | | |
| Common | | | | |
| offloadable | | | | |
| APNs | | | | |

Referring to Table 7, the “List of WLAN” field and “List of common offloadable APNs” field are added to the current eNB configuration update acknowledge message.

This scheme, i.e., the method for broadcasting, may apply to connected mode UEs in case that the eNB treats the UE in the same principle. In addition, it may also be fit for the idle mode UEs in case that broadcasting is used.

2) Second, a method for dedicated signaling according to an embodiment of the present invention is described. In the method for dedicated signaling according to an embodiment of the present invention, the eNB transmits a clear indication of WLAN offloading support or a clear indication of WLAN information request to the MME. Upon receiving the indication of the WLAN offloading support or the indication of the WLAN information request, the MME transmits a list of supported WLAN for the specific UE, e.g., SSIDs, to the eNB. The list of supported WLAN may indicate the possible WLAN related IDs for the specific UE. Further, the MME may transmit the corresponding APN information for each E-UTRAN radio access bearer (E-RAB) of the specific UE, together with the list of supported WLAN. The APN information may indicate the specific APN for the specific E-RAB. Upon receiving the list of supported WLAN, and optionally, the APN information, the eNB decides which APN to offload for the specific UE based on its current load, and transmit dedicated signaling to the specific UE with WLAN information (e.g., SSID) and APN(s).

The indication of the WLAN offloading support or the indication of WLAN information request, the list of supported WLAN, and the APN information described above may be transmitted via existing messages specified in 3GPP LTE specification or via newly defined messages, in the method for dedicated signaling according to an embodiment of the present invention. Various messages carrying the indication of the WLAN offloading support or the indication of WLAN information request, the list of supported WLAN, and the APN information, in the method for dedicated signaling according to an embodiment of the present invention are described below.

The indication of the WLAN offloading support or the indication of WLAN information request may be transmitted via an initial UE message, which is specified in section 9.1.7.1 of 3GPP TS 36.413 V11.6.0 (2013-12). The initial UE message is transmitted by the eNB to transfer the initial layer 3 message to the MME over the S1 interface. Table 8 shows an example of the initial UE message according to an embodiment of the present invention.

TABLE 8

| | | | | | | |
|---|---|---|---|---|---|---|
| | | | IE type | | | |
| | | | and | Semantics | | Assigned |
| IE/Group Name | Presence | Range | reference | description | Criticality | Criticality |

| | | | | | |
|---|---|---|---|---|---|
| Message Type | M | 9.2.1.1 | | YES | ignore |
| eNB UE S1AP ID | M | 9.2.3.4 | | YES | reject |
| NAS-PDU | M | 9.2.3.5 | | YES | reject |
| TAI | Mzl | 9.2.3.16 | Indicating the | YES | reject |
| | | | Tracking Area | | |
| | | | from which the | | |
| | | | UE has sent the | | |
| | | | NAS message. | | |
| E-UTRAN CGI | M | 9.2.1.38 | Indicating the E- | YES | ignore |
| | | | UTRAN CGI | | |
| | | | from which the | | |
| | | | UE has sent the | | |
| | | | NAS message. | | |
| RRC Establishment | M | 9.2.1.3a | | YES | Ignore |
| Cause | | | | | |
| S-TMSI | O | 9.2.3.6 | | YES | reject |
| CSG Id | O | 9.2.1.62 | | YES | reject |
| GUMMEI | O | 9.2.3.9 | | YES | reject |
| Cell Access Mode | O | 9.2.1.74 | | YES | reject |
| GW Transport | O | Transport | Indicating GW | YES | ignore |
| Layer Address | | Layer | Transport Layer | | |
| | | Address | Address if the | | |
| | | 9.2.2.1 | GW is collocated | | |
| | | | with eNB. | | |
| Relay Node | O | 9.2.1.79 | Indicating a | YES | reject |
| Indicator | | | relay node. | | |
| GUMMEI Type | O | ENUMERATED | | YES | ignore |
| | | (native, | | | |
| | | mapped, . . . ) | | | |
| Tunnel Information | O | Tunnel | Indicating | YES | ignore |
| for BBF | | Information | HeNB's Local IP | | |
| | | 9.2.2.3 | Address | | |
| | | | assigned by the | | |
| | | | broadband | | |
| | | | access provider, | | |
| | | | UDP port | | |
| | | | Number. | | |
| Indication of | O | | | | |
| WLAN offloading | | | | | |
| support or | | | | | |
| indication of | | | | | |
| WLAN | | | | | |
| information | | | | | |
| request | | | | | |

Referring to Table 8, the “Indication of WLAN offloading support or indication of WLAN information request” field is added to the current initial UE message.

Or, the indication of the WLAN offloading support or the indication of WLAN information request may be transmitted via an uplink NAS transport message, which is specified in section 9.1.7.3 of 3GPP TS 36.413 V11.6.0 (2013-12). The uplink NAS transport message is transmitted by the eNB and is used for carrying NAS information over the S1 interface. Table 9 shows an example of the uplink NAS transport message according to an embodiment of the present invention.

TABLE 9

| | | | | | | |
|---|---|---|---|---|---|---|
| | | | IE type | | | |
| | | | and | Semantics | | Assigned |
| IE/Group Name | Presence | Range | reference | description | Criticality | Criticality |

| | | | | | |
|---|---|---|---|---|---|
| Message Type | M | 9.2.1.1 | | YES | ignore |
| MME UE S1AP ID | M | 9.2.3.3 | | YES | reject |
| eNB UE S1AP ID | M | 9.2.3.4 | | YES | reject |
| NAS-PDU | M | 9.2.3.5 | | YES | reject |
| E-UTRAN CGI | M | 9.2.1.38 | | YES | ignore |
| TAI | M | 9.2.3.16 | | YES | ignore |
| GW Transport | O | Transport | Indicating GW | YES | ignore |
| Layer Address | | Layer | Transport Layer | | |
| | | Address | Address if the GW | | |
| | | 9.2.2.1 | is collocated with | | |
| | | | eNB. | | |
| Indication of | O | | | | |
| WLAN offloading | | | | | |
| support or | | | | | |
| indication of | | | | | |
| WLAN | | | | | |
| information | | | | | |
| request | | | | | |

Referring to Table 9, the “Indication of WLAN offloading support or indication of WLAN information request” field is added to the current uplink NAS transport message.

For UE attach or UE-initiated service request procedure, the list of supported WLAN and the APN information may be transmitted via an initial context setup request message, which is specified in section 9.1.4.1 of 3GPP TS 36.413 V11.6.0 (2013-12). The initial context setup request message is transmitted by the MME to request the setup of a UE context. Table 10 shows an example of the initial context setup request message according to an embodiment of the present invention.

TABLE 10

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.1.1 | | YES | reject |
| MME UE S1AP | M | | 9.2.3.3 | | YES | reject |
| ID | | | | | | |
| eNB UE S1AP ID | M | | 9.2.3.4 | | YES | reject |
| UE Aggregate | M | | 9.2.1.20 | | YES | reject |
| Maximum Bit Rate | | | | | | |
| E-RAB to Be | | 1 | | | YES | reject |
| Setup List | | | | | | |
| >E-RAB to Be | | 1 . . . <maxnoofE- | | | EACH | reject |
| Setup Item IEs | | RABs> | | | | |
| >>E-RAB ID | M | | 9.2.1.2 | | — | |
| >>E-RAB Level | M | | 9.2.1.15 | Includes | — | |
| QoS | | | | necessary | | |
| Parameters | | | | QoS | | |
| | | | | parameters. | | |
| >>Transport | M | | 9.2.2.1 | | — | |
| Layer Address | | | | | | |
| >>GTP-TEID | M | | 9.2.2.2 | | — | |
| >>NAS-PDU | O | | 9.2.3.5 | | — | |
| >>Correlation | O | | 9.2.1.80 | | YES | ignore |
| ID | | | | | | |
| >>APN ID | O | | | | | |
| UE Security | M | | 9.2.1.40 | | YES | reject |
| Capabilities | | | | | | |
| Security Key | M | | 9.2.1.41 | The KeNB is | YES | reject |
| | | | | provided | | |
| | | | | after the key- | | |
| | | | | generation in | | |
| | | | | the MME, | | |
| | | | | see TS | | |
| | | | | 33.401 [15]. | | |
| Trace Activation | O | | 9.2.1.4 | | YES | ignore |
| Handover | O | | 9.2.1.22 | | YES | ignore |
| Restriction List | | | | | | |
| UE Radio | O | | 9.2.1.27 | | YES | ignore |
| Capability | | | | | | |
| Subscriber Profile | O | | 9.2.1.39 | | YES | ignore |
| ID for | | | | | | |
| RAT/Frequency | | | | | | |
| priority | | | | | | |
| CS Fallback | O | | 9.2.3.21 | | YES | reject |
| Indicator | | | | | | |
| SRVCC Operation | O | | 9.2.1.58 | | YES | ignore |
| Possible | | | | | | |
| CSG Membership | O | | 9.2.1.73 | | YES | ignore |
| Status | | | | | | |
| Registered LAI | O | | 9.2.3.1 | | YES | ignore |
| GUMMEI | O | | 9.2.3.9 | This IE | YES | ignore |
| | | | | indicates the | | |
| | | | | MME | | |
| | | | | serving the | | |
| | | | | UE. | | |
| MME UE S1AP | O | | 9.2.3.3 | This IE | YES | ignore |
| ID 2 | | | | indicates the | | |
| | | | | MME UE | | |
| | | | | S1AP ID | | |
| | | | | assigned by | | |
| | | | | the MME. | | |
| Management | O | | 9.2.1.83 | | YES | ignore |
| Based MDT | | | | | | |
| Allowed | | | | | | |
| Management | O | | MDT | | YES | ignore |
| Based MDT | | | PLMN | | | |
| PLMN List | | | List | | | |
| | | | 9.2.1.89 | | | |
| List of WLAN | O | | | | | |

Referring to Table 10, the “List of WLAN” field and “APN ID” field are added to the current initial context setup request message.

For other dedicated bearer activation/modification procedure, the E-RAB setup request/modification procedure may be used. The list of supported WLAN and the APN information may be transmitted via an E-RAB setup request message, which is specified in section 9.1.3.1 of 3GPP TS 36.413 V11.6.0 (2013-12). The E-RAB setup request message is transmitted by the MME and is used to request the eNB to assign resources on Uu and S1 for one or several E-RABs. Table 11 shows an example of the E-RAB setup request message according to an embodiment of the present invention.

TABLE 11

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.1.1 | | YES | reject |
| MME UE S1AP ID | M | | 9.2.3.3 | | YES | reject |
| eNB UE S1AP ID | M | | 9.2.3.4 | | YES | reject |
| UE Aggregate | O | | 9.2.1.20 | | YES | reject |
| Maximum Bit Rate | | | | | | |
| E-RAB to be Setup | | 1 | | | YES | reject |
| List | | | | | | |
| >E-RAB To Be | | 1 . . . <maxnoofE- | | | EACH | reject |
| Setup Item IEs | | RABs> | | | | |
| >>E-RAB ID | M | | 9.2.1.2 | | — | |
| >>E-RAB Level | M | | 9.2.1.15 | Includes | — | |
| QoS Parameters | | | | necessary | | |
| | | | | QoS | | |
| | | | | parameters. | | |
| >>Transport | M | | 9.2.2.1 | | — | |
| Layer Address | | | | | | |
| >>GTP-TEID | M | | 9.2.2.2 | EPC | — | |
| | | | | TEID. | | |
| >>NAS-PDU | M | | 9.2.3.5 | | — | |
| >>Correlation ID | O | | 9.2.1.80 | | YES | ignore |
| >>APN ID | O | | | | | |
| List of WLAN | O | | | | | |

Referring to Table 11, the “List of WLAN” field and “APN ID” field are added to the current E-RAB setup request message.

Or, the list of supported WLAN and the APN information may be transmitted via an E-RAB modify request message, which is specified in section 9.1.3.3 of 3GPP TS 36.413 V 11.6.0 (2013-12). The E-RAB modify request message is transmitted by the MME and is used to request the eNB to modify the data radio bearers and the allocated resources on Uu and Si for one or several E-RABs. Table 12 shows an example of the E-RAB modify request message according to an embodiment of the present invention.

TABLE 12

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.1.1 | | YES | reject |
| MME UE S1AP | M | | 9.2.3.3 | | YES | reject |
| ID | | | | | | |
| eNB UE S1AP ID | M | | 9.2.3.4 | | YES | reject |
| UE Aggregate | O | | 9.2.1.20 | | YES | reject |
| Maximum Bit Rate | | | | | | |
| E-RAB to be | | 1 | | | YES | reject |
| Modified List | | | | | | |
| >E-RAB To Be | | 1 . . . <maxnoofE- | | | EACH | reject |
| Modified Item | | RABs> | | | | |
| IEs | | | | | | |
| >>E-RAB ID | M | | 9.2.1.2 | | — | |
| >>E-RAB | M | | 9.2.1.15 | Includes | — | |
| Level QoS | | | | necessary | | |
| Parameters | | | | QoS | | |
| | | | | parameters. | | |
| >>NAS-PDU | M | | 9.2.3.5 | | — | |
| >>APN ID | O | | | | | |
| List of WLAN | O | | | | | |

Referring to Table 12, the “List of WLAN” field and “APN ID” field are added to the current E-RAB modify request message.

3) Third, a method during mobility procedure according to an embodiment of the present invention is described. After the UE handovers to neighbor eNB by the X2 handover procedure, the target eNB needs also to know the WLAN information and the corresponding APN information so that it is ready to do offloading for the UE if it is necessary. In the method during the X2 handover procedure according to an embodiment of the present invention, the source eNB transmits a handover request message including a list of supported WLAN and the corresponding APN information for all E-RABs to the target eNB. The list of supported WLAN may indicate the possible WLAN related IDs for the specific UE. The corresponding APN information may indicate the specific APN for the specific E-RAB. The list of supported WLAN and/or the corresponding APN information may use new information elements (IEs) in the handover request message or the existing IEs in the handover request message. Upon receiving the handover request message, the target eNB may use the WLAN information later to do offloading.

Table 13 and 14 shows an example of the handover request message according to an embodiment of the present invention. The handover request message is specified in section 9.1.5.4 of 3GPP TS 36.413 V11.6.0 (2013-12). The handover request message is transmitted by the source eNB to the target eNB to request the preparation of resources for a handover.

TABLE 13

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.13 | | YES | reject |
| Old eNB UE X2AP | M | | eNB UE | Allocated at | YES | reject |
| ID | | | X2AP | the source | | |
| | | | ID | eNB | | |
| | | | 9.2.24 | | | |
| Cause | M | | 9.2.6 | | YES | ignore |
| Target Cell ID | M | | ECGI | | YES | reject |
| | | | 9.2.14 | | | |
| GUMMEI | M | | 9.2.16 | | YES | reject |
| UE Context | | 1 | | | YES | reject |
| Information | | | | | | |
| >MME UE S1AP | M | | INTEGER | MME UE | — | — |
| ID | | | R (0 . . . 2³² − | S1AP ID | | |
| | | | 1) | allocated at | | |
| | | | | the MME | | |
| >UE Security | M | | 9.2.29 | | — | — |
| Capabilities | | | | | | |
| >AS Security | M | | 9.2.30 | | — | — |
| Information | | | | | | |
| >UE Aggregate | M | | 9.2.12 | | — | — |
| Maximum Bit Rate | | | | | | |
| >Subscriber Profile | O | | 9.2.25 | | — | — |
| ID for | | | | | | |
| RAT/Frequency | | | | | | |
| priority | | | | | | |
| >E-RABs To Be | | 1 | | | — | — |
| Setup List | | | | | | |
| >>E-RABs To Be | | 1 . . . <maxnoofBearers> | | | EACH | ignore |
| Setup Item | | | | | | |
| >>>E-RAB ID | M | | 9.2.23 | | — | — |
| >>>E-RAB | M | | 9.2.9 | Includes | — | — |
| Level QoS | | | | necessary | | |
| Parameters | | | | QoS | | |
| | | | | parameters | | |
| >>>DL | O | | 9.2.5 | | — | — |
| Forwarding | | | | | | |
| >>>UL GTP | M | | GTP | SGW | — | — |
| Tunnel | | | Tunnel | endpoint of | | |
| Endpoint | | | Endpoint | the S1 | | |
| | | | 9.2.1 | transport | | |
| | | | | bearer. For | | |
| | | | | delivery of | | |
| | | | | UL PDUs. | | |
| >>>APN ID | O | | | | | |
| >RRC Context | M | | OCTET | Includes the | — | — |
| | | | STRING | RRC | | |
| | | | | Handover | | |
| | | | | Preparation | | |
| | | | | Information | | |
| | | | | message as | | |
| | | | | defined in | | |
| | | | | subclause | | |
| | | | | 10.2.2 of TS | | |
| | | | | 36.331 [9] | | |
| >Handover | O | | 9.2.3 | | — | — |
| Restriction List | | | | | | |
| >Location | O | | 9.2.21 | Includes the | — | — |
| Reporting | | | | necessary | | |
| Information | | | | parameters | | |
| | | | | for location | | |
| | | | | reporting | | |
| >Management | O | | 9.2.59 | | YES | ignore |
| Based MDT | | | | | | |
| Allowed | | | | | | |
| >Management | O | | MDT | | YES | ignore |
| Based MDT | | | PLMN | | | |
| PLMN List | | | List | | | |
| | | | 9.2.64 | | | |
| UE History | M | | 9.2.38 | Same | YES | ignore |
| Information | | | | definition as | | |
| | | | | in TS 36.413 | | |
| | | | | [4] | | |
| Trace Activation | O | | 9.2.2 | | YES | ignore |
| SRVCC Operation | O | | 9.2.33 | | YES | ignore |
| Possible | | | | | | |
| CSG Membership | O | | 9.2.52 | | YES | reject |
| Status | | | | | | |
| Mobility | O | | BIT | Information | YES | ignore |
| Information | | | STRING | related to the | | |
| | | | (SIZE | handover; the | | |
| | | | (32)) | source eNB | | |
| | | | | provides it in | | |
| | | | | order to | | |
| | | | | enable later | | |
| | | | | analysis of | | |
| | | | | the conditions | | |
| | | | | that led to a | | |
| | | | | wrong HO. | | |
| List of WLAN | O | | | | | |

TABLE 14

| Range bound | Explanation |
|---|---|
| maxnoofBearers | Maximum no. of E-RABs. Value is 256 |
| maxnoofMDTPLMNs | PLMNs in the Management Based MDT PLMN |
| | list. Value is 16. |

Referring to Table 13, the “List of WLAN” field and “APN ID” field are added to the current handover request message.

Alternatively, in the method during the X2 handover procedure according to an embodiment of the present invention, the target eNB transmits path switch request message including a clear indication of WLAN offloading support or a clear indication of WLAN information request to the MME. Upon receiving the path switch request message, the MME transmits a path switch request acknowledge message including a list of supported WLAN and APN information for all accepted E-RABs to the target eNB. The list of supported WLAN may indicate the possible WLAN related IDs for the specific UE. The APN information may indicate the specific APN for the specific E-RAB. The list of supported WLAN and/or the APN information may use new IEs in the path switch request acknowledge message or the existing IEs in the path switch request acknowledge message. Upon receiving the path switch request acknowledge message, the target eNB may use the WLAN information later to do offloading.

Table 15 and 16 shows an example of the path switch request message according to an embodiment of the present invention. The path switch request message is specified in section 9.1.5.8 of 3GPP TS 36.413 V11.6.0 (2013-12). The path switch request message is transmitted by the eNB to request the MME to switch DL GPRS tunneling protocol (GTP) tunnel termination point(s) from one end-point to another.

TABLE 15

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.1.1 | | YES | reject |
| eNB UE S1AP ID | M | | 9.2.3.4 | | YES | reject |
| E-RAB To Be | | 1 | | | YES | reject |
| Switched in | | | | | | |
| Downlink List | | | | | | |
| >E-RABs Switched | | 1 . . . <maxnoofE- | | | EACH | reject |
| in Downlink Item | | RABs> | | | | |
| IEs | | | | | | |
| >>E-RAB ID | M | | 9.2.1.2 | | — | |
| >>Transport Layer | M | | 9.2.2.1 | | — | |
| address | | | | | | |
| >>GTP-TEID | M | | 9.2.2.2 | To | — | |
| | | | | deliver | | |
| | | | | DL | | |
| | | | | PDUs. | | |
| Source MME UE | M | | 9.2.3.3 | | YES | reject |
| S1AP ID | | | | | | |
| E-UTRAN CGI | M | | 9.2.1.38 | | YES | ignore |
| TAI | M | | 9.2.3.16 | | YES | ignore |
| UE Security | M | | 9.2.1.40 | | YES | ignore |
| Capabilities | | | | | | |
| CSG Id | O | | 9.2.1.62 | | YES | ignore |
| Cell Access Mode | O | | 9.2.1.74 | | YES | ignore |
| Source MME | O | | 9.2.3.9 | | YES | ignore |
| GUMMEI | | | | | | |
| CSG Membership | O | | 9.2.1.73 | | YES | ignore |
| Status | | | | | | |
| Tunnel Information | O | | Tunnel | Indicating | YES | ignore |
| for BBF | | | Information | HeNB's | | |
| | | | 9.2.2.3 | Local IP | | |
| | | | | Address | | |
| | | | | assigned | | |
| | | | | by the | | |
| | | | | broadband | | |
| | | | | access | | |
| | | | | provider, | | |
| | | | | UDP | | |
| | | | | port | | |
| | | | | Number. | | |
| WLAN information | O | | | | | |
| request or WLAN | | | | | | |
| support indication | | | | | | |

TABLE 16

| Range bound | Explanation |
|---|---|
| maxnoofE-RABs | Maximum no. of E-RABs for one UE. Value is 256. |

Referring to Table 15, the “WLAN information request or WLAN support indication” field is added to the current path switch request message.

Table 17 and 18 shows an example of the path switch request acknowledge message according to an embodiment of the present invention. The path switch request acknowledge message is specified in section 9.1.5.9 of 3GPP TS 36.413 V11.6.0 (2013-12). The path switch request acknowledge message is transmitted by the MME to inform the eNB that the path switch has been successfully completed in the EPC.

TABLE 17

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.1.1 | | YES | reject |
| MME UE S1AP ID | M | | 9.2.3.3 | | YES | ignore |
| eNB UE S1AP ID | M | | 9.2.3.4 | | YES | ignore |
| UE Aggregate | O | | 9.2.1.20 | | YES | ignore |
| Maximum Bit Rate | | | | | | |
| E-RAB To Be | | 0 . . . 1 | | | YES | ignore |
| Switched in Uplink | | | | | | |
| List | | | | | | |
| >E-RABs Switched | | 1 . . . <maxnoofE- | | | EACH | ignore |
| in Uplink Item IEs | | RABs> | | | | |
| >>E-RAB ID | M | | 9.2.1.2 | | — | |
| >>Transport | M | | 9.2.2.1 | | — | |
| Layer Address | | | | | | |
| >>GTP-TEID | M | | 9.2.2.2 | | — | |
| >>APN ID | O | | | | | |
| E-RAB To Be | O | | E-RAB | A value for | YES | ignore |
| Released List | | | List | E-RAB ID | | |
| | | | 9.2.1.36 | shall only | | |
| | | | | be present | | |
| | | | | once in E- | | |
| | | | | RAB To Be | | |
| | | | | Switched in | | |
| | | | | Uplink List | | |
| | | | | IE + E-RAB | | |
| | | | | to Be | | |
| | | | | Released | | |
| | | | | List IE. | | |
| Security Context | M | | 9.2.1.26 | One pair of | YES | reject |
| | | | | {NCC, NH} | | |
| | | | | is provided. | | |
| Criticality | O | | 9.2.1.21 | | YES | ignore |
| Diagnostics | | | | | | |
| MME UE S1AP ID 2 | O | | 9.2.3.3 | This IE | YES | ignore |
| | | | | indicates the | | |
| | | | | MME UE | | |
| | | | | S1AP ID | | |
| | | | | assigned by | | |
| | | | | the MME. | | |
| CSG Membership | O | | 9.2.1.73 | | YES | ignore |
| Status | | | | | | |
| List of WLAN | O | | | | | |

TABLE 18

| Range bound | Explanation |
|---|---|
| maxnoofE-RABs | Maximum no. of E-RABs for one UE. Value is 256. |

Referring to Table 17, the “List of WLAN” field and “APN ID” field are added to the current path switch request acknowledge message.

In the method during the S1 handover procedure according to an embodiment of the present invention, the MME transmits a handover command message including the list of supported WLAN and APN information for all E-RABs to the target eNB.

Table 19 shows an example of the handover command message according to an embodiment of the present invention. The handover command message is specified in section 9.1.5.2 of 3GPP TS 36.413 V11.6.0 (2013-12). The handover command message is transmitted by the MME to inform the source eNB that resources for the handover have been prepared at the target side.

TABLE 19

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.1.1 | | YES | reject |
| MME UE S1AP ID | M | | 9.2.3.3 | | YES | reject |
| eNB UE S1AP ID | M | | 9.2.3.4 | | YES | reject |
| Handover Type | M | | 9.2.1.13 | | YES | reject |
| NAS Security | C- | | 9.2.3.30 | The eNB | YES | reject |
| Parameters from E- | iftoUT | | | shall use | | |
| UTRAN | RANG | | | this IE as | | |
| | ERAN | | | specified in | | |
| | | | | TS 33.401 | | |
| | | | | [15]. | | |
| E-RABs Subject to | | 0 . . . 1 | | | YES | ignore |
| Forwarding List | | | | | | |
| >E-RABs Subject | | 1 . . . <maxnoofE- | | | EACH | ignore |
| to Forwarding Item | | RABs> | | | | |
| IEs | | | | | | |
| >>E-RAB ID | M | | 9.2.1.2 | | — | |
| >>DL Transport | O | | 9.2.2.1 | | — | |
| Layer Address | | | | | | |
| >>DL GTP-TEID | O | | 9.2.2.2 | To deliver | — | |
| | | | | forwarded | | |
| | | | | DL PDCP | | |
| | | | | SDUs. | | |
| >>UL Transport | O | | 9.2.2.1 | | — | |
| Layer Address | | | | | | |
| >>UL GTP-TEID | O | | 9.2.2.2 | To deliver | — | |
| | | | | forwarded | | |
| | | | | UL PDCP | | |
| | | | | SDUs. | | |
| >>APN ID | O | | | | | |
| E-RABs to Release | O | | E-RAB | | YES | ignore |
| List | | | List | | | |
| | | | 9.2.1.36 | | | |
| Target to Source | M | | 9.2.1.57 | | YES | reject |
| Transparent | | | | | | |
| Container | | | | | | |
| Target to Source | O | | Target to | | YES | reject |
| Transparent | | | Source | | | |
| Container Secondary | | | Transparent | | | |
| | | | Container | | | |
| | | | 9.2.1.57 | | | |
| Criticality | O | | 9.2.1.21 | | YES | ignore |
| Diagnostics | | | | | | |
| List of WLAN | O | | | | | |

Referring to Table 19, the “List of WLAN” field and “APN ID” field are added to the current handover command message.

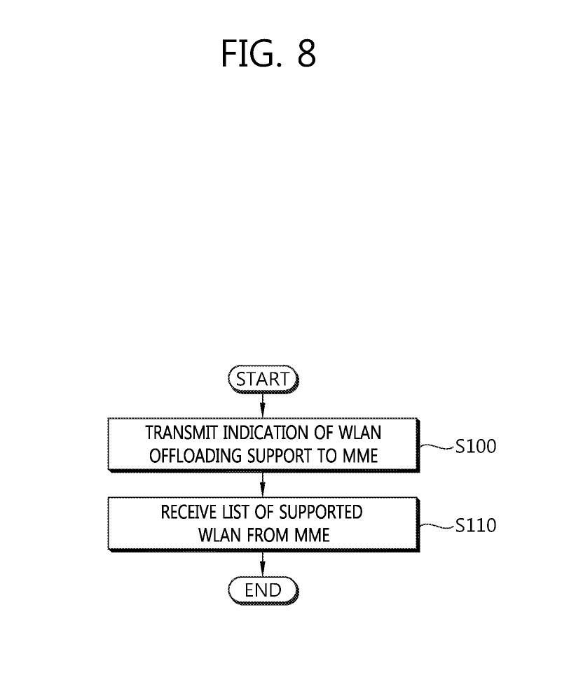

FIG. 8 shows an example of a method for obtaining WLAN information according to an embodiment of the present invention. In step S110, the eNB transmits an indication of WLAN offloading support to the MME. In step S110, the eNB receives a list of supported WLAN from the MME.

For the broadcasting method according to an embodiment of the present invention, the list of supported WLAN may indicate common possible WLAN related IDs for the eNB. A list of common APNs which indicates common possible APNs which can be offloaded may be further received. The eNB may decide which APN, among the list of common APNs, to offload, and broadcast WLAN information and the decided APN to UEs. The UEs may include idle mode UEs and connected mode UEs. The indication of WLAN offloading support may be transmitted via an S1 setup request message, and the list of supported WLAN may be received via an S1 setup response message. Alternatively, the indication of WLAN offloading support may be transmitted via an eNB configuration update message, and the list of supported WLAN may be received via an eNB configuration update acknowledge message.

For the dedicated signaling method according to an embodiment of the present invention, the list of supported WLAN may indicate possible WLAN related IDs for a specific UE. Information on an APN for a specific E-RAB of a specific UE may be further received. The eNB may decide which APN to offload for the specific UE, and transmit WLAN information and the decided APN to the specific UE via a dedicated signaling. The indication of WLAN offloading support may be transmitted via one of an initial UE message or an uplink NAS transport message, and the list of supported WLAN may be received via one of an initial context setup request message, an E-RAB setup request message or an E-RAB modify request message.

For the method during mobility procedure according to an embodiment of the present invention, the the indication of WLAN offloading support may be transmitted via a path switch request message, and the list of supported WLAN may be received via a path switch request acknowledge message.

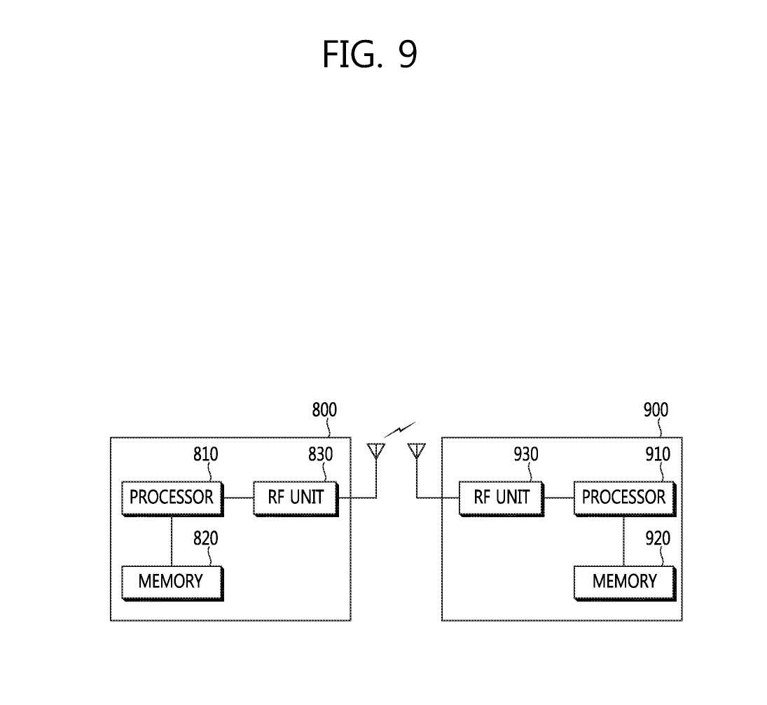

FIG. 9 shows a wireless communication system to implement an embodiment of the present invention.

An eNB 800 includes a processor 810, a memory 820, and a radio frequency (RF) unit 830. The processor 810 may be configured to implement proposed functions, procedures, and/or methods in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

An MME 900 includes a processor 910, a memory 920 and an RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What is claimed is:

1. A method for obtaining, by an evolved NodeB (eNB), wireless local area network (WLAN) information in a wireless communication system, the method comprising:
transmitting an indication of WLAN offloading support to a mobility management entity (MME); and
receiving a list of supported WLAN from the MME.

2. The method of claim 1, wherein the list of supported WLAN indicates common possible WLAN related identifiers (IDs) for the eNB.

3. The method of claim 1, wherein the list of supported WLAN indicates possible WLAN related IDs for a specific user equipment (UE).

4. The method of claim 1, wherein the indication of WLAN offloading support is transmitted via an S1 setup request message, and
wherein the list of supported WLAN is received via an S1 setup response message.

5. The method of claim 1, wherein the indication of WLAN offloading support is transmitted via an eNB configuration update message, and
wherein the list of supported WLAN is received via an eNB configuration update acknowledge message.

6. The method of claim 1, wherein the indication of WLAN offloading support is transmitted via one of an initial UE message or an uplink non-access stratum (NAS) transport message, and
wherein the list of supported WLAN is received via one of an initial context setup request message, an E-UTRAN radio access bearer (E-RAB) setup request message or an E-RAB modify request message.

7. The method of claim 1, wherein the indication of WLAN offloading support is transmitted via a path switch request message, and
wherein the list of supported WLAN is received via a path switch request acknowledge message.

8. The method of claim 1, further comprising receiving a list of common access point names (APNs) which indicates common possible APNs which can be offloaded.

9. The method of claim 8, further comprising deciding which APN, among the list of common APNs, to offload, and
broadcasting WLAN information and the decided APN to UEs.

10. The method of claim 9, wherein the UEs includes idle mode UEs and connected mode UEs.

11. The method of claim 1, further comprising receiving information on an APN for a specific E-RAB of a specific UE.

12. The method of claim 11, further comprising deciding which APN to offload for the specific UE, and
transmitting WLAN information and the decided APN to the specific UE via a dedicated signaling.

13. A method for transmitting, by a mobility management entity (MME), wireless local area network (WLAN) information in a wireless communication system, the method comprising:
receiving an indication of WLAN offloading support from an evolved NodeB (eNB); and
transmitting a list of supported WLAN to the eNB.

14. The method of claim 13, wherein the list of supported WLAN indicates common possible WLAN related identifiers (IDs) for the eNB.

15. The method of claim 13, wherein the list of supported WLAN indicates possible WLAN related IDs for a specific user equipment (UE).
